(19) United States
(12) Patent Application Publication
(10) Pub. No.: US 2007/0128519 A1
(43) Pub. Date: Jun. 7, 2007

(54) Activated carbon precursor, activated carbon, manufacturing method for the same, polarizable electrodes and electric double-layer capacitor

(75) Inventors: Kazuma Inoue, Okayama (JP); Nozomu Sugo, Okayama (JP); Hideharu Iwasaki, Okayama (JP); Takeshi Fujino, Saitama (JP); Minoru Noguchi, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/604,378

(22) Filed: Nov. 27, 2006

(30) Foreign Application Priority Data
Dec. 1, 2005 (JP) P. 2005-347914

(51) Int. Cl. H01M 4/58; C01B 31/08

(52) U.S. Cl. 429/231.4; 502/427

(57) ABSTRACT

The use of an activated carbon precursor having a weight reduction rate of 1% or less from the temperature at which its weight reduction ends according to thermogravimetric analysis, to 500 C, when manufacturing activated carbon by activating an activated carbon precursor obtained by heating a mixture of a carbonaceous material and an alkali metal hydroxide at a reduced pressure and/or in the presence of an inert gas.

### BACKGROUND OF THE INVENTION

1. Field of the Invention

The present invention relates to an activated carbon precursor giving activated carbon which is suitable as a material for a polarizable electrode for an electric double-layer capacitor, an activated carbon manufactured therefrom, a method of manufacturing the same and a polarizable electrode and an electric double-layer capacitor made by employing such activated carbon.

2. Description of Related Art

It is generally known that the capacitance of a polarizable electrode for an electric double-layer capacitor depends mainly on factors such as the surface area of the polarizable electrode, the capacity of the electric double layer per unit area and the resistance of the electrode. Also, improvements relating to those factors have been required for improving its capacitance. In practice, an improved capacitance per unit volume of the polarizable electrode and thereby a reduction in volume of the capacitor, as well as an improvement in density of the electrode itself, have also been required for reducing the weight and size of the capacitor.

In order to comply with those requirements, it is often the case that activated carbon as a material for a polarizable electrode for an electric double-layer capacitor is produced by activating a carbonaceous material, such as a resin, palm shell, pitch or coal, with e.g. water vapor or gas under acidic conditions. However, there has recently been proposed a method which produces activated carbon on a batch type production by employing a chemical having a strong oxidizing power, such as potassium hydroxide, to make an electric double-layer capacity of high capacitance (see Japanese Patent Unexamined Publication JP-A-10-199767). The continuous production of such activated carbon has also been proposed (see Japanese Patent Unexamined Publication JP-A-06-144816 and JP-A-06-144817).

The method of producing activated carbon as disclosed in JP-A-10-199767 above can produce activated carbon showing a capacitance which is satisfactory to some extent (for example, 25 to 27 F/cc) for activated carbon as a material for a polarizable electrode for an electric double-layer capacitor owing to the use of an activator having a strong oxidizing power, such as potassium hydroxide. However, its further improvement in capacitance has been required for use with a capacitor having a large capacity for installation in a motor vehicle. Moreover, as it is a batch type method of production, it has been a problem that it is not always an excellent method from an industrial standpoint of mass production.

Although the method of producing activated carbon as disclosed in JP-A-06-144816 and JP-A-06-144817 is an industrially advantageous method of production as it is a continuous method of production, it has been a problem that the activated carbon produced by any such continuous method of production does not exhibit any satisfactory capacitance for activated carbon as a material for a polarizable electrode for an electric double-layer capacitor.

Thus, the batch type production of activated carbon by the activation of a carbonaceous material with an alkali metal hydroxide is required to produce activated carbon of higher capacitance and the continuous production of activated carbon by the activation of a carbonaceous material with an alkali metal hydroxide is also required to produce activated carbon of higher capacitance. In the latter case where activated carbon is continuously produced by the activation of a carbonaceous material with an alkali metal hydroxide, the application of the continuous process as disclosed in JP-A-06-144816 and JP-A-06-144817 to the batch process for production as disclosed in JP-A-10-199767 above does certainly make continuous production possible, but does not make it possible to produce any product showing a satisfactory capacitance for activated carbon as a material for a polarizable electrode for an electric double-layer capacitor.

### SUMMARY OF THE INVENTION

It is an object of the present invention to make it possible to obtain activated carbon which is suitable for a polarizable electrode for an electric double-layer capacitor when manufacturing activated carbon on a batch or continuous process by activating a carbonaceous material with an alkali metal hydroxide.

As a result of our diligently repeated studies, we, the inventors of the present invention, have made the present invention by discovering that activated carbon showing a good capacitance suitable for a polarizable electrode for an electric double-layer capacitor can be obtained by dewatering a mixture of a carbonaceous material and an alkali metal hydroxide under heat at a reduced pressure or in the presence of an inert gas before activating it to prepare an activated carbon precursor showing a specific weight reduction in thermal analysis and activating it.

According to one of aspects of the invention, there is provided an activated carbon precursor obtained by heating a mixture of a carbonaceous material and an alkali metal hydroxide at a reduced pressure and/or in a presence of an inert gas,

wherein a weight reduction rate, which is measured in a thermogravimetric analysis from a temperature at which an end of a weight reduction is confirmed to 500° C., is 1% or less.

According to one of aspects of the invention, there is provided a manufacturing method of an activated carbon, comprising:

mixing a carbonaceous material and an alkali metal hydroxide;

heating the mixture at a temperature of 100° C. to 380° C. at a reduced pressure and/or in the presence of an inert gas to produce an activated carbon precursor having a weight reduction rate, which is measured in a thermogravimetric analysis from a temperature at which an end of a weight reduction is confirmed to 500° C., being 1% or less; and

activating the activated carbon precursor.

According to one of aspects of the invention, there is provided a polarizable electrode molded from a mixture comprising the activated carbon obtained by the aforementioned manufacturing method, a binder and an electrically conductive filler.

According to one of aspects of the invention, there is provided a selecting method of selecting a carbonaceous material for a polarizable electrode from an activated carbon precursor obtained by heating a mixture of a carbonaceous material and an alkali metal hydroxide at a reduced pressure and/or in the presence of an inert gas, the selecting method comprising:

selecting the activated carbon precursor having a weight reduction rate of 1% or less, which is measured in a thermogravimetric analysis from a temperature at which an end of a weight reduction is confirmed to 500° C., as the polarizable electrode.

The activated carbon precursor of the present invention is an activated carbon precursor obtained by heating a mixture of a carbonaceous material and an alkali metal hydroxide at a reduced pressure and/or in the presence of an inert gas, and having a weight reduction rate of 1% or less measured by thermogravimetric analysis (TGA) from the temperature (primary inflection point) at which the ending of its weight reduction is confirmed by to 500° C. The activation of the activated carbon precursor having such thermoanalytical characteristics makes it possible to obtain easily activated carbon showing a capacitance suitable for a polarizable electrode for a capacitor, though no clear reason is known.

### BRIEF DESCRIPTION OF THE DRAWINGS

FIG. 1 is a chart showing an example of thermogravimetric analysis; and

FIG. 2 is a diagram outlining an example of electric double-layer capacitor.

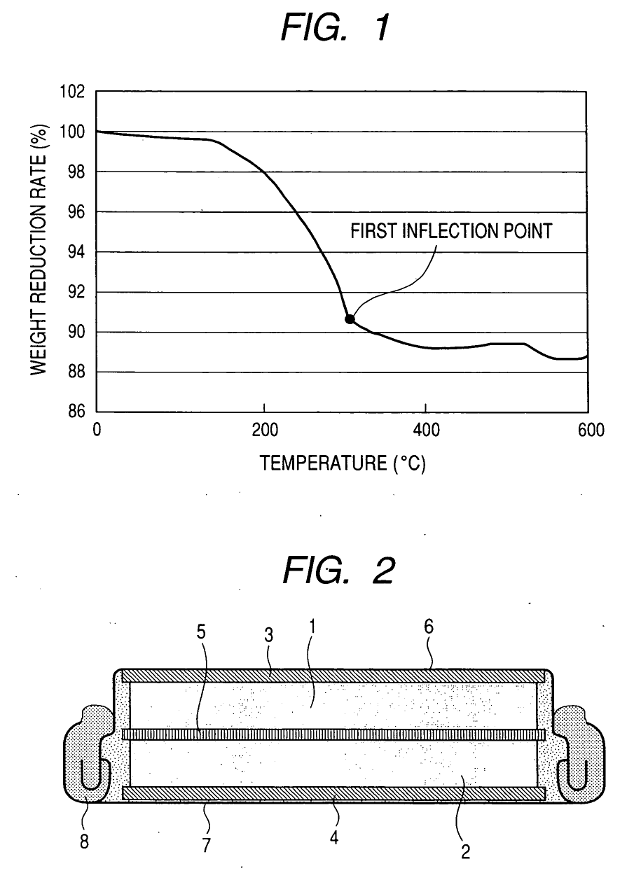

### DETAILED DESCRIPTION OF EXEMPLARY EMBODIMENTS OF THE INVENTION

### Embodiments

The activated carbon precursor of the present invention is obtained by heating a mixture of a carbonaceous material and an alkali metal hydroxide at a reduced pressure and/or in the presence of an inert gas. The heating of the mixture mainly causes its dehydration. Its heating facilitates its activation as will be described later.

While a carbonaceous material of e.g. the vegetal, mineral or resinous series can be mentioned as the carbonaceous material to be used in accordance with the present invention, an easily graphitizable carbonaceous material is preferably used to realize a high capacitance. Specific examples of easily graphitizable carbonaceous materials include coal pitch, petroleum pitch, mesophase pitch such as natural or synthetic mesophase pitch, and coke such as coal pitch coke or petroleum coke. Among others, coal pitch coke, petroleum coke or synthetic mesophase pitch are preferred. The carbonaceous material is not limited in shape, but may be of any of various shapes, such as fibrous or sheet-like.

The carbonaceous material is crushed and mixed thoroughly with an alkali metal hydroxide prior to use. The crushed material preferably has a maximum grain length of 0.1 mm or less, more preferably 500 μm or less and still more preferably 200 μm or less along its major axis so that its activation may be carried out effectively, as will be described. Its maximum length along its major axis can be ascertained by, for example, examining an electron micrograph of a random sample of the crushed carbonaceous material. The crushing of the carbonaceous material can be performed by a known crushing machine, such as a cone crusher, a double-roll crusher, a disk crusher, a rotary crusher, a ball mill, a centrifugal rolling mill, a ring rolling mill or a centrifugal ball mill.

Examples of alkali metal hydroxides are particles of sodium, potassium, lithium and cesium hydroxides, or mixtures thereof. Sodium, potassium or cesium hydroxide, or a mixture thereof are preferred to ensure easy availability and industrial safety and realize a high capacitance.

Any alkali metal hydroxide having a water content of 1 to 20% by weight may be used, but one having a water content of 1 to 10% by weight is preferred as it is easier to handle. The alkali metal hydroxide is preferably crushed to an average particle diameter of 1 mm or less by a crushing machine as stated above prior to its use. When it is in a lump form, it may be crushed into particles by a crushing machine as stated above. The term ‘particle’ as herein used means a finely divided form as a whole, including a spherical, crushed or powdery form.

The crushed carbonaceous material and alkali metal hydroxide are preferably mixed thoroughly by usually employing a mixing machine so as to form as uniform a mixture as possible, while they are kept in a solid state. They are kept in a solid state, because when the alkali metal hydroxide melt to form any slurry, corrosion is likely occurred on the mixing machine. The mixing machine is not particularly limited in type, but a known rotary or stationary vessel type mixing machine may be used, though a rotary vessel type mixing machine may be preferred to form a uniform mixture. As the alkali metal hydroxide usually absorbs moisture, it is desirable to perform their mixing in a dry air or nitrogen or like atmosphere so that it may not absorb moisture. The mixing machine is preferably made of nickel or an alloy consisting mainly of nickel so that its corrosion may be reduced as far as possible. The temperature at which the carbonaceous material and alkali metal hydroxide are mixed together is not particularly limited, but a room temperature is usually satisfactory.

If the amount of the alkali metal hydroxide which is used is too small for the carbonaceous material, its activation tends to become insufficient and non-uniform, resulting in activated carbon varying in properties. If it is too large, it is not only uneconomical, but also an excessive degree of activation occurs, tending to result in a lowering of capacitance per volume of carbonaceous material, though the capacitance per weight of carbonaceous material may tend to increase. Accordingly, the amount of the alkali metal hydroxide which is used is preferably from 1 to 1,000 parts by mass relative to 100 parts by mass of the carbonaceous material, more preferably from 120 to 400 parts by mass and still more preferably from 130 to 300 parts by mass.

The mixing of the carbonaceous material and the alkali metal hydroxide is performed at a reduced pressure and/or in the presence of an inert gas. The reduced pressure includes both a pressure reduced from the open atmosphere and a pressure reduced in the presence of an inert gas, such as nitrogen or argon. When they are mixed in the presence of an inert gas, they may be mixed not only at a reduced pressure, but also at an atmospheric pressure. In order to restrain the melting of the alkali metal hydroxide, they are preferably mixed at a reduced pressure in the range of, for example, 1.3332 to 1333.2 Pa (0.01 to 10 torr)

The heating of the carbonaceous material and alkali metal hydroxide which have been mixed is the dehydration treatment of their mixture, as stated before. Their heating is performed at a reduced pressure and/or in the presence of an inert gas by employing a pressure similar to that at which they have been mixed as stated above, and as it is preferable to perform dehydration, while keeping their mixture in a solid form when heating it, it is preferable to heat it at a reduced pressure in the range of, for example, 1.3332 to 1333.2 Pa (0.01 to 10 torr) to restrain the melting of the alkali metal hydroxide. The heating temperature for dehydration is preferably from 100° C. to 380° C., as it is feared that too low a temperature may result in insufficient dehydration, while too high a temperature forms a slurry. Heating at a temperature which is low within that range is satisfactory in the event of a high degree of pressure reduction.

The activated carbon precursor of the present invention has a weight reduction rate of 1% or less being measured by thermogravimetric analysis (TGA) conforming to JIS (Japanese Industrial Standard) K7120 from the temperature, at which its weight reduction due to the vaporization of its vaporizable components, mainly water, ends is confirmed, to 500° C. The “temperature at which its weight reduction ends” as confirmed by thermogravimetric analysis (TGA) means the temperature at the first inflection point (primary inflection point) in the curve obtained by plotting the “weight reduction” against the “temperature” in the event of heating at a predetermined rate of temperature elevation. The “primary inflection point” is selected as a standard point for the weight reduction, since the weight reduction due to the components adsorbed physically to the materials, such a water, ends at that temperature, and 500° C. is selected, since the volatilization of free carbon from materials, such as tar, ends at 500° C.

The activated carbon precursor of the present invention is limited to one having a weight reduction rate of 1% or less according to thermogravimetric analysis (TGA) conforming to JIS K7120, from the temperature at the primary inflection point to 500° C. Since the activation of any activated carbon precursor having a weight reduction over 1% causes free carbon to adhere to the activating chamber, close a gas passage of the chamber. The close of the gas passage causes to dangerously elevate its internal pressure when activated carbon is produced in a batch way. On the other hand, when activated carbon is produced continuously, such adhering matter adheres to the continuously processed carbonaceous material, too, resulting in deteriorating the performance of the activated carbon. Moreover, free matter blocks the pores of activated carbon, whether it may be produced in a batch or continuous way.

The activated carbon precursor of the present invention as described above gives activated carbon useful as a material for a polarizable electrode for an electric double-layer capacitor by known activation employing an alkali metal hydroxide, preferably by activation under heat. More specifically, a mixture of a carbonaceous material and an alkali metal hydroxide is heated at a temperature of 100° C. to 380° C. at a reduced pressure and/or in the presence of an inert gas to produce an activated carbon precursor having a weight reduction rate of 1% or less according to thermogravimetric analysis from the temperature at which its weight reduction ends to 500° C., and the activated carbon precursor is activated to produce activated carbon. The manufacture of the activated carbon precursor and the manufacture of activated carbon may each be carried out in a batch or continuous way, so that activated carbon can be manufactured with a high degree of industrial advantages.

The method of manufacturing an activated carbon precursor according to the present invention as described above is view form another point of view, it turns out to be a method of selecting an activated carbon precursor suitable as a material for a polarizable electrode. The present invention according to that aspect thereof is a method of selecting a carbonaceous material for a polarizable electrode from an activated carbon precursor obtained by heating a mixture of a carbonaceous material and an alkali metal hydroxide at a reduced pressure and/or in the presence of an inert gas, which comprises selecting an activated carbon precursor having a weight reduction rate of 1% or less measured by thermogravimetric analysis from the temperature at which the ending of its weight reduction to 500° C. The features constituting the invention relating to the selecting method have the same meanings as the corresponding features constituting the method of manufacturing an activated carbon precursor according to the present invention as already described.

If too high a temperature is employed for activation when activated carbon is manufactured, there is obtained activated carbon having a large surface area, but an electric double-layer capacitor made by using a polarizable electrode molded from the activated carbon has a low capacitance and the volatilization of metallic potassium occurring from activation presents a extremely danger. If the activation temperature is too low, fine structures to be removed from the system by activation remain unremoved and give an electrode material having a high electrical resistance. Accordingly, the activation temperature is preferably from 500° C. to 900° C. and more preferably from 550° C. to 800° C.

While it is necessary to heat the activated carbon precursor and raise it temperature to the predetermined level as stated above for its activation, its temperature is preferably raised at a rate of 50° C. to 1,000° C. per hour, since too rapid a temperature elevation is undesirable for any palletized product of activated carbon to maintain its shape, while too slow a temperature elevation is likely to result in a capacitor failing to perform satisfactorily.

When activated carbon is obtained by using sodium or potassium hydroxide or a mixture thereof as the alkali metal hydroxide as already stated in connection with the activated carbon precursor of the present invention, its capacitance shows a critical increase when its activation temperature is about 650° C. or about 730° C. Its activation is preferably carried out by, for example, heating at a rate of usually about 4° C. per minute from room temperature. A known rotary, fluidizing or moving type activator can, for example, be used for continuous activation with an alkali metal hydroxide. It is preferable to make the activator of a material consisting mainly of nickel to prevent its corrosion.

It is preferable to pass an inert gas, such as nitrogen or argon gas, through the activator to expel safely any gas occurring therein during activation. The inert gas is preferably moved through the activator at a rate of 0.01 cm per minute or higher and more preferably at a rate of 0.1 cm per minute or higher, depending on the method of activation which is employed. While activated carbon is cooled after activation, its cooling is preferably carried out in the presence of an inert gas, such as nitrogen or argon, to suppress the combustion of activated carbon. Then, the activated carbon is washed with water in a customary way for the removal of any alkali metal therefrom and dried in a customary way to yield activated carbon having a capacitance desirable for a polarizable electrode for an electric double-layer capacitor.

The activated carbon obtained as described is preferably used as a material for a polarizable electrode for an electric double-layer capacitor. Any usually known method can be employed for manufacturing a polarizable electrode. For example, activated carbon and a binder, such as polyvinylidene fluoride or polytetrafluoroethylene, are thoroughly kneaded together and their mixture is molded under pressure in a mold, or rolled into a sheet and stamped into the shape as required to make a polarizable electrode in sheet form.

When they are kneaded, it is possible to add preferably up to several percent of an electrically conductive substance, such as electrically conductive carbon or fine metal particles, in order to make a polarizable electrode having a low resistance and a small volume. It is alternatively possible to coat a current collector with the kneaded mixture to make a coated electrode.

When they are kneaded, it is also possible to add any solvent, such as alcohol, N-methylpyrrolidone or other organic compound, any dispersant or any of various kinds of additives, if necessary. The addition of any solvent facilitates the use of the kneaded mixture as a coating agent and thereby the coating of a current collector with the kneaded mixture to make a coated electrode.

While heat can be applied when they are kneaded, it is necessary to employ an appropriate temperature, since any temperature higher than is required not only causes the deterioration of the binder, but also affects the physical properties of activated carbon due to the surface structure of its components, for example, its specific surface area. It is usually preferable to knead the mixture at a temperature not exceeding 300° C.

The polarizable electrode made as described has a high capacitance and is preferably used in e.g. a cylinder, laminated or coin type capacitor. A coin type capacitor is outlined in FIG. 2.

In FIG. 2, 1 and 2 are polarizable electrodes, 3 and 4 are current collecting members, 5 is a separator such as a nonwoven polypropylene fabric, 6 is a top cover of e.g. stainless steel, 7 is a bottom cover and 8 is a gasket, which form a capacitor when the case is filled with an electrolyte. Thus, in a case, the capacitor has a pair of polarizable electrodes and a porous ion-permeable separator therebetween and the polarizable electrodes and separator are wetted with the electrolyte. Current collecting members are disposed between the polarizable electrodes and the case, or welded to the electrodes and the case is sealed by a sealing member (mentioned above as gasket) between the top cover and bottom case to prevent any leakage of the electrolyte.

Examples of the solvents for the electrolyte used in the capacitor are:

carbonates such as dimethyl carbonate, diethyl carbonate, ethylene carbonate and propylene carbonate;

nitrites such as acetonitrile and propionitrile;

lactones such as γ-butyrolactone, α-methyl-γ-butyrolactone, β-methyl-γ-butyrolactone, γ-valerolactone and 3-methyl-γ-valerolactone;

sulfoxides such as dimethylsulfoxide and diethylsulfoxide;

amides such as dimethylformamide and diethylformamide;

ethers such as tetrahydrofuran and dimethoxyethane;

dimethylsulforane; and sulforane.

These organic solvents may be used as a single solvent or a mixture of two or more solvents.

Examples of the electrolytes dissolved in those organic solvents are:

ammonium tetrafluoroborates such as tetraethylammonium tetrafluoroborate, tetramethylammonium tetrafluoroborate, tetrapropylammonium tetrafluoroborate, tetrabutylammonium tetrafluoroborate, trimethylethylammonium tetrafluoroborate, triethylmethylammonium tetrafluoroborate, diethyldimethylammonium tetrafluoroborate, N-ethyl N-methylpyrrolidinium tetrafluoroborate, N,N-tetramethylene-pyrrolidinium tetrafluoroborate and 1-ethyl-3-methylimidazolium tetrafluoroborate;

ammonium perchlorates such as tetraethylammonium perchlorate, tetramethylammonium perchlorate, tetrpropylammonium perchlorate, tetrabutylammonium perchlorate, trimethylethylammonium perchlorate, triethyl-methylammonium perchlorate, diethyldimethylammonium perchlorate, N-ethyl-N-methylpyrrolidinium perchlorate, N,N-tetramethylenepyrrolidinium perchlorate and 1-ethyl-3-methylimidazolium perchlorate; and

ammonium hexafluorophosphates such as tetraethylammonium hexafluorophosphate, tetramethylammonium hexafluorophosphate, tetrapropylammonium hexafluorophosphate, tetrabutylammonium hexafluorophosphate, trimethylethylammonium hexafluorophosphate, triethylmethylammonium hexafluorophosphate and diethyldimethylammonium hexafluorophosphate.

When a salt which is a solid at normal temperature, such as tetrabutylammonium tetrafluoroborate, is used as the electrolyte, the electrolyte preferably has a concentration of from 0.5 to 5 moles/liter (M/L) and more preferably from 1.0 to 2.5M/L, since too low a concentration is likely to result in a low capacitance due to the shortage of the electrolyte, while too high a concentration is likely to result in the precipitation of the salt at a low temperature. When an ionic liquid, such as 1-ethyl-3-methylimidazolium tetrafluoro-borate, is used as the electrolyte, its concentration does not have any upper limit unless it solidifies in the temperature range in which it is used.

The present invention will now be described more specifically by examples, though these examples are not intended for limiting the present invention.

### REFERENCE EXAMPLE 1

Petroleum pitch coke obtained by the heat treatment of the cracking residue of petroleum was heated at 500° C. for an hour in a nitrogen gas stream and cooled to room temperature in six hours to prepare petroleum pitch coke.

### REFERENCE EXAMPLE 2

Petroleum pitch coke was prepared by heating at 700° C. and otherwise repeating Reference Example 1.

### REFERENCE EXAMPLE 3

Coal pitch coke was prepared by changing the cracking residue of petroleum to the cracking residue of coal, heating coal pitch coke at 600° C. and otherwise repeating Reference Example 1.

### REFERENCE EXAMPLE 4

Synthetic mesophase pitch was oxidized by heating to 200° C. in the air so as to have an oxygen content of 4% by weight, was heated at 680° C. for three hours and was allowed to cool down to room temperature in six hours to prepare synthetic mesophase pitch.

### EXAMPLE 1

8 g of a crushed product obtained by crushing petroleum pitch coke as prepared in Reference Example 2 to a particle size of 20 μm or less was placed in a nickel reactor provided with a thermometer and a stirrer, 16 g of 95% potassium hydroxide crushed to an average particle size of 1 mm or less was added thereto, and their mixture was dried for two hours in a vacuum having a temperature of 300° C. and a pressure of 0.2 mmHg under stirring. After it had been cooled to room temperature, it was restored to atmospheric pressure in a nitrogen gas atmosphere. The solid was taken out and heated from room temperature to 600° C. in a nitrogen gas stream flowing at a rate of 500 ml/min. in a thermogravimetric analyzer (TG50 of Mettler Toledo Co., Ltd.), whereby its mass reduction from the temperature at its primary inflection point to 500° C. was measured. The results are shown in Table 1.

The solid as obtained was introduced into a nickel rotary kiln having an inside diameter of 1 inch and heated to 700° C. at a rate of 200° C. per hour in a nitrogen gas stream flowing at a rate of 10 ml/min. After it had reached 700° C., it was held thereat for an hour and then cooled to room temperature in two hours. After nitrogen had been passed for an hour through a distilled water bubbler, it was thrown into 50 ml of water. 200 ml of a 1N hydrochloric acid solution was added and it was neutralized and washed in eight hours, was then washed continuously with 3 l of distilled water for the removal of the salts and was dried to yield 6.6 g of activated carbon.

The activated carbon as obtained was pulverized into an activated carbon powder having an average particle size of 5 to 20 μm and a mixture containing 80% by weight of activated carbon powder, 10% by weight of electrically conductive carbon and 10% by weight of polytetrafluoroethylene was kneaded. The kneaded mixture was rolled into a sheet having a thickness of 150 μm. The sheet was bonded to a stainless steel cover with an electrically conductive paste containing activated carbon and a fine powder of graphite and dried, and a disk having a diameter of 15 mm was stamped out of the sheet and cover and dried at 200° C. for 12 hours to yield a polarizable electrode in sheet form.

A current collecting member, a polarizable electrode, a nonwoven polypropylene fabric, another polarizable electrode and another current collecting member were laid one upon another in their order in a stainless steel case, as shown in FIG. 2, in a glow box having a dew point of −80° C. or below, a propylene carbonate solution containing tetraethylammonium tetrafluoroborate at a concentration of 1 mole per liter was introduced therein to impregnate the polarizable electrodes, and an insulating gasket of polypropylene was swaged over a stainless steel top cover to seal the case, whereby a capacitor was made.

The capacitor as obtained was charged at a constant current of 3 mA/cm² of electrode surface area at room temperature until a voltage of 2.5 V, received a supplementary charge at a constant voltage of 2.5 V for 30 minutes and was discharged at a rate of 3 mA/cm², by using an apparatus of Hioki Denki for evaluating an electric double-layer capacitor. This charge and discharge cycle was repeated 10 times to obtain a discharge curve from 1.2 V to 1.0 V and it was used to calculate the average capacitance of the capacitor in accordance with an established rule. The results are shown in Table 1.

### EXAMPLE 2

Activated carbon and a capacitor were made by employing coal pitch coke as prepared in Reference Example 3 and otherwise repeating Example 1. The results of the measurements are shown in Table 1.

### EXAMPLE 3

Activated carbon and a capacitor were made by employing synthetic mesophase pitch as prepared in Reference Example 4 and otherwise repeating Example 1. The results of the measurements are shown in Table 1.

### COMPARATIVE EXAMPLE 1

Activated carbon and a capacitor were made by employing petroleum pitch coke as prepared in Reference Example 1 and otherwise repeating Example 1. The results of the measurements are shown in Table 1.

### COMPARATIVE EXAMPLE 2

Activated carbon and an electric double-layer capacitor were made by employing unheated coal pitch coke and otherwise repeating Example 1. The results of the measurements are shown in Table 1.

TABLE 1

| | Adherence | | | |
|---|---|---|---|---|
| | to rotary | Primary | Weight | |
| | kiln inner | inflection | reduction | Capacitance |
| | wall | point (° C.) | rate (%) | (F/cc) |
| Example 1 | No | 300 | 0.87 | 34.2 |
| Example 2 | No | 322 | 0.91 | 34.7 |
| Example 3 | No | 304 | 0.92 | 33.2 |
| Comparative | Yes | 315 | 1.45 | 29.3 |
| Example 1 | | | | |
| Comparative | Yes | 279 | 2.52 | 24.4 |
| Example 2 | | | | |

As is obvious from Table 1, the capacitors according to Examples 1 and 2 made by employing activated carbon precursors having a weight reduction rate of 1% or less measured by thermogravimetric analysis from the temperature at which their weight reduction ended (primary inflection point) to 500° C. showed an increase in capacitance of about 17% and about 42%, respectively, over the capacitors according to Comparative Examples 1 and 2, respectively, not employing any such precursor.

The activated carbon precursor of the present invention is an activated carbon precursor obtained by heating a mixture of a carbonaceous material and an alkali metal hydroxide at a reduced pressure and/or in the presence of an inert gas, and having a weight reduction rate of 1% or less measured by thermogravimetric analysis (TGA) from the temperature (primary inflection point) at which the ending of its weight reduction is confirmed to 500° C. The batch or continuous activation of the activated carbon precursor having such thermoanalytical characteristics makes it possible to obtain easily activated carbon showing a capacitance suitable for a polarizable electrode for a capacitor.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. An activated carbon precursor obtained by heating a mixture of a carbonaceous material and an alkali metal hydroxide at a reduced pressure and/or in a presence of an inert gas,
wherein a weight reduction rate, which is measured in a thermogravimetric analysis from a temperature at which an end of a weight reduction is confirmed to 500° C., is 1% or less.

2. The activated carbon precursor as set forth in claim 1, wherein the mixture is heated at a temperature of 100° C. to 380° C.

3. The activated carbon precursor as set forth in claim 1, wherein the carbonaceous material is an easily graphitizable carbonaceous material.

4. The activated carbon precursor as set forth in claim 3, wherein the easily graphitizable carbonaceous material is coal pitch coke or petroleum coke.

5. The activated carbon precursor as set forth in claim 3, wherein the easily graphitizable carbonaceous material is mesophase pitch.

6. The activated carbon precursor as set forth in claim 5, wherein the mesophase pitch is a synthetic mesophase pitch.

7. The activated carbon precursor as set forth in claim 1, wherein the alkali metal hydroxide is potassium hydroxide.

8. The activated carbon precursor as set forth in claim 1, wherein
before mixing with the alkali metal hydroxide, the carbonaceous material has an average particle diameter of 0.1 mm or less, and
before mixing with the carbonaceous material, the alkali metal hydroxide has an average particle diameter of 1 mm or less.

9. The activated carbon precursor as set forth in claim 1, wherein a mixing proportions of the carbonaceous material and alkali metal hydroxide are 1 to 1,000 parts by mass of alkali metal hydroxide relative to 100 parts by mass of carbonaceous material.

10. An activated carbon obtained by activating an activated carbon precursor as set forth in claim 1.

11. A manufacturing method of an activated carbon, comprising:
mixing a carbonaceous material and an alkali metal hydroxide;
heating the mixture at a temperature of 100° C. to 380° C. at a reduced pressure and/or in the presence of an inert gas to produce an activated carbon precursor having a weight reduction rate, which is measured in a thermogravimetric analysis from a temperature at which an end of a weight reduction is confirmed to 500° C., being 1% or less; and
activating the activated carbon precursor.

12. A polarizable electrode molded from a mixture comprising:
the activated carbon as set forth in claim 10;
a binder; and
an electrically conductive filler.

13. An electric double-layer capacitor including a polarizable electrode as set forth in claim 12.

14. A selecting method of selecting a carbonaceous material for a polarizable electrode from an activated carbon precursor obtained by heating a mixture of a carbonaceous material and an alkali metal hydroxide at a reduced pressure and/or in the presence of an inert gas, the selecting method comprising:
selecting the activated carbon precursor having a weight reduction rate of 1% or less, which is measured in a thermogravimetric analysis from a temperature at which an end of a weight reduction is confirmed to 500° C., as the polarizable electrode.

15. The manufacturing method of the activated carbon as set forth in claim 11, wherein the mixture is heated at a range from 1.3332 to 1333.2 Pa.

16. The manufacturing method of the activated carbon as set forth in claim 11, wherein the carbonaceous material and the alkali metal hydroxide are mixed at a range from 1.3332 to 1333.2 Pa.

17. The activated carbon precursor as set forth in claim 9, wherein a mixing proportions of the carbonaceous material and alkali metal hydroxide are 130 to 300 parts by mass of alkali metal hydroxide relative to 100 parts by mass of carbonaceous material.
